(19) United States
(12) Patent Application Publication
(10) Pub. No.: US 2019/0289331 A1
(43) Pub. Date: Sep. 19, 2019

(54) IMAGE PROCESSING APPARATUS FOR PERFORMING FILTERING ON RESTORED IMAGES AND FILTERING METHOD THEREOF

(71) Applicant: SAMSUNG ELECTRONICS CO., LTD., SUWON-SI (KR)

(72) Inventor: JU-WON BYUN, HWASEONG-SI (KR)

(21) Appl. No.: 16/233,792

(22) Filed: Dec. 27, 2018

(30) Foreign Application Priority Data
Mar. 13, 2018 (KR) 10-2018-0029298

(51) Int. Cl. H04N 19/86; H04N 19/117

(52) U.S. Cl. CPC H04N 19/86; H04N 19/117

(57) ABSTRACT

An image processing apparatus for performing filtering on a restored image, and a filtering method: perform deblocking filtering for removing at least some deterioration of a boundary between a plurality of restored blocks included in the restored image; generate pixel parameters of the plurality of restored blocks in parallel with performing the deblocking filtering; and perform post-deblocking filtering on the plurality of restored blocks, based on the pixel parameters.

### CROSS-REFERENCE TO RELATED APPLICATION

This application claims the benefit of Korean Patent Application No. 10-2018-0029298, filed on Mar. 13, 2018, in the Korean Intellectual Property Office, the disclosure of which is incorporated herein in its entirety by reference.

### BACKGROUND

The inventive concept relates to an image processing apparatus, and more particularly, to an image processing apparatus for performing a filtering operation on a restored image, and a filtering method thereof.

As hardware for reproducing and storing video content having high resolution or high image quality is developed and distributed, the need for video codecs for effectively encoding or decoding video content having high resolution or high image quality is increasing. Particularly, next-generation video codecs perform deblocking filtering on a restored image, and then, perform post-deblocking filtering. In this case, in order to determine a post-deblocking filter for post-deblocking filtering, as a pixel parameter is generated by using a restored image on which deblocking has been performed by a deblocking filter, a deblocking filtering result is reflected in the pixel parameter, and thus, the pixel parameter depends on the accuracy of the deblocking filtering result. Also, since the pixel parameter is generated after a deblocking filtering operation is completed, an image processing time is inefficiently consumed, and moreover, complexity increases in implementing hardware of a video codec.

### SUMMARY

The inventive concept provides an image processing apparatus and a filtering method thereof, which perform a filtering operation for minimizing a difference between an original image and a restored image.

According to an aspect of the inventive concept, there is provided an image processing apparatus including a deblocking filter configured to receive a restored image and perform deblocking filtering for removing at least some deterioration of a boundary between a plurality of restored blocks included in the restored image to produce a deblocked restored image, a pixel parameter generator configured to receive the restored image and in response thereto generate pixel parameters of the plurality of restored blocks in parallel with the deblocking filtering, and a post-deblocking filter configured to receive the pixel parameters and the deblocked restored image and to perform post-deblocking filtering on the plurality of restored blocks, based on the pixel parameters.

According to another aspect of the inventive concept, there is provided a filtering method for a restored image, the filtering method including: a deblocking filter performing deblocking filtering for removing at least some deterioration of a boundary between a plurality of restored blocks included in the restored image, a filter parameter generator generating pixel parameters of the plurality of restored blocks in parallel with performing the deblocking filtering, and a post-deblocking filter performing post-deblocking filtering on the plurality of restored blocks, based on the pixel parameters.

According to yet another aspect of the inventive concept, there is provided a non-transitory computer-readable recording medium storing thereon a computer program, the computer program being configured for execution by a processor to: perform deblocking filtering for removing deterioration of a boundary between a plurality of restored blocks included in a restored image, generate pixel parameters of the plurality of restored blocks in parallel with performing the deblocking filtering, and perform post-deblocking filtering on the plurality of restored blocks, based on the pixel parameters.

According to still another aspect of the inventive concept, there is provided a device, comprising: an in-loop filtering device, comprising: a deblocking filter configured to receive a restored image including a plurality of restored blacks, and to perform deblocking filtering for removing at least some deterioration of a boundary between the plurality of restored blocks to produce a deblocked restored image; a pixel parameter generator configured to receive the restored image and, in parallel with the deblocking filtering, to generate from the restored image pixel parameters of the plurality of restored blocks; and a post-deblocking filter configured to receive the pixel parameters and the deblocked restored image and to perform post-deblocking filtering on the plurality of restored blocks, based on the pixel parameters, to produce a filtered signal; a decoded image buffer configured to receive and store the filtered signal; and a predictor configured to receive the filtered signal from the decoded image buffer and in response thereto to produce a prediction signal.

### BRIEF DESCRIPTION OF THE DRAWINGS

Embodiments of the inventive concept will be more clearly understood from the following detailed description taken in conjunction with the accompanying drawings.

FIG. 1 is a block diagram illustrating an embodiment of an image processing system including an image processing apparatus.

FIG. 2 is a schematic block diagram of an embodiment of an encoding unit.

FIG. 3 is a schematic block diagram of an embodiment of a decoding unit.

FIG. 4 is a schematic block diagram for describing an embodiment of an operation of an in-loop filtering unit of FIG. 2 or 3

FIG. 5 is a flowchart for describing an embodiment of a filtering method.

FIGS. 6A, 6B, 6C and 6D are diagrams for describing details of a first pixel parameter of FIG. 4.

FIG. 7 is a diagram for describing details of a second pixel parameter of FIG. 4.

FIGS. 8A and 8B are diagrams for describing the use of a buffer of an embodiment of an image processing apparatus.

FIGS. 9A and 9B are diagrams for describing an operation of an embodiment of an in-loop filtering unit associated with pixel parameter compensation.

FIGS. 10A, 10B and 10C are diagrams for describing an operation of an embodiment of an in-loop filtering unit.

FIG. 11 illustrates a concept of an embodiment of a unit of encoding.

FIG. 12 is a block diagram illustrating an example where an embodiment of an image processing method is implemented by a processor executing software.

FIG. 13 is a block diagram illustrating a computing system including an embodiment of an image processing apparatus.

### DETAILED DESCRIPTION OF THE EMBODIMENTS

Hereinafter, embodiments will be described in detail with reference to the accompanying drawings.

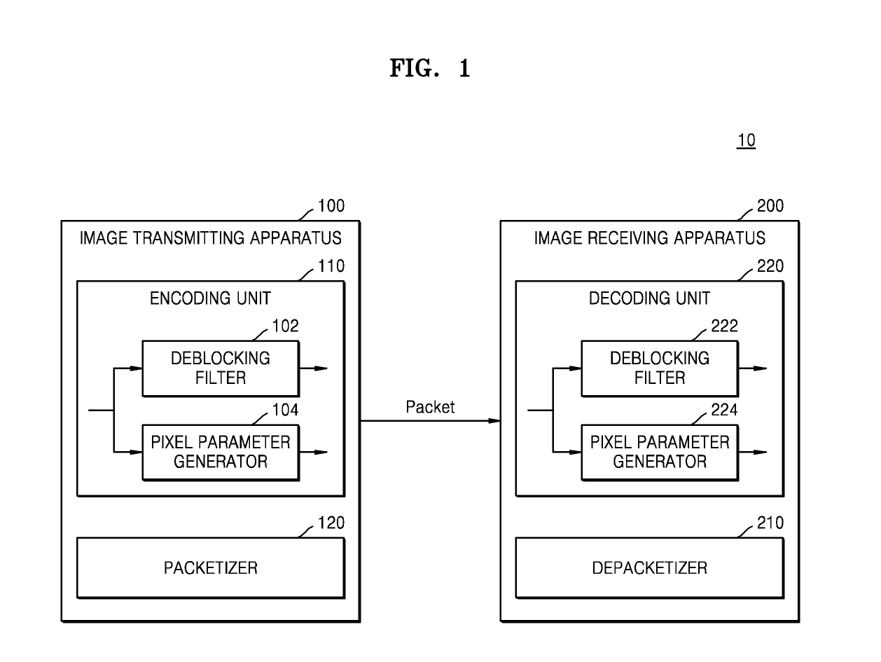

FIG. 1 is a block diagram illustrating an embodiment of an image processing system 10 including an image processing apparatus.

Image processing system 10 illustrated in FIG. 1 may include an image transmitting apparatus 100 and an image receiving apparatus 200 as an embodiment of the image processing apparatus. Alternatively, the image processing apparatus according to an embodiment may include an image transmitting function and an image receiving function, and thus, may correspond to image processing system 10.

Image processing system 10 may correspond to various kinds of systems. For example, in image processing system 10, image transmitting apparatus 100 and image receiving apparatus 200 may transmit or receive information including an image over a wireless or wired network. For example, if image processing system 10 corresponds to a wireless communication system, each of image transmitting apparatus 100 and image receiving apparatus 200 may be terminal equipment of a smartphone or the like, which encodes an image to transmit the encoded image to a base station, or decodes an image received from the base station. Alternatively, image processing system 10 may correspond to various kinds of network systems such as Internet broadcast or Internet protocol televisions (IPTVs).

Image transmitting apparatus 100 may perform an encoding operation based on various image standards such as moving picture experts group (MPEG), H.264/advanced video coding (H.264/AVC), VP8, and high efficiency video coding (HEVC). An image encoding operation may be performed on a certain unit image (for example, a frame image), and each of frame images may be compressed based on inter prediction or intra prediction. If compression is based on intra prediction, a current frame image may be compressed without referring to a previous frame image. If compression is based on inter prediction, a current frame image may be compressed with reference to one or more previous frame images (for example, restored images). Hereinafter, embodiments will be described with reference to HEVC, which is one of the image standards, but may be applied to the above-described various image standards such as H.264/AVC.

According to an example embodiment, image transmitting apparatus 100 may include an encoding unit 110 and a packetizer 120. Also, image receiving apparatus 200 may include a depacketizer 210 and a decoding unit 220.

Encoding unit 110 may perform an encoding operation based on a largest coding unit (LCU). For example, the LCU may be defined based on a frame image, and based on various image standards, the LCU may be referred to as a macroblock. For example, the LCU may correspond to a size including 64*64 pixels.

In performing encoding, the LCU may be divided into a plurality of coding units (CUs). The LCU or each of the CUs may correspond to a unit of encoding, and encoding unit 110 may perform a frequency conversion and quantization operation on pixel values, based on the unit of encoding. Therefore, a unit by which conversion and quantization are performed may correspond to a CU, and a maximum value (for example, a maximum conversion size) of the unit by which conversion and quantization are performed may correspond to the LCU.

Encoding unit 110 may perform a decoding operation based on dequantization and inverse conversion on an encoded frame image so as to perform inter prediction, thereby generating a restored image. The restored image, unlike an original image, may generally include an artifact which degrades subjective quality. For example, an artifact may include a block artifact and a noise artifact. In order to remove the artifact from the restored image, the restored image may be transferred to a deblocking filter 102. Deblocking filter 102 may remove a block phenomenon appearing in the restored image. That is, deblocking filter 102 may be an image processing filter for removing a block phenomenon which appears in a restored image obtained through decoding after an input image is encoded by units of encoding. Deblocking filter 102 may perform deblocking filtering for reducing a block phenomenon in pixels disposed in a boundary region of a maximum unit of encoding or a tree-structure unit of encoding.

An embodiment of encoding unit 110 may generate pixel parameters by using a pixel parameter generator 104 in parallel with performing the deblocking filtering. Each of the pixel parameters may be information necessary for determining a filter parameter of a post-deblocking filter (not shown) for removing the artifact in the restored image. Pixel parameter generator 104 may receive the same restored image which is input to deblocking filter 102, and based on a pixel value of each of restored blocks included in the restored image, pixel parameter generator 104 may generate a pixel parameter corresponding to each of the restored blocks. A block unit (or a restored block unit) may be a unit by which the post-deblocking filter (not shown) is applied to a decoded image later. For example, the post-deblocking filter may include at least one of a deringing filter and an adaptive loop filter. A filter parameter of the deringing filter or the adaptive filter may be determined based on the pixel parameters generated by pixel parameter generator 104, and details relevant thereto will be described below.

In an embodiment, a restored image obtained through deblocking by deblocking filter 102 and the pixel parameters generated by pixel parameter generator 104 may be output to the post-deblocking filter (not shown). A filter parameter of the post-deblocking filter (not shown) may be determined based on the pixel parameters, and the post-deblocking filter (not shown) corresponding to the determined filter parameter may be applied to the restored image obtained through deblocking.

Packetizer 120 may transmit data of the frame image, obtained through encoding as described above, to image receiving apparatus 200 in a bitstream format. Packetizer 120 may perform a packetization operation on encoded data and may transmit a packet (or a bitstream) to image receiving apparatus 200 over a network. Furthermore, the packet may include the encoded data, and moreover, at least one of the pixel parameters generated by pixel parameter generator 104, and the parameters of the post-deblocking filter (not shown) may be encoded and added to the packet.

Image receiving apparatus 200 may receive the packet, and depacketizer 210 may extract actual information (for example, a payload) from the packet received over the network. Decoding unit 220 may perform a decoding operation on the received information to restore the frame image.

Decoding unit 220 may include a deblocking filter 222 and a pixel parameter generator 224. In an embodiment, decoding unit 220 may generate pixel parameters by using pixel parameter generator 224 in parallel with deblocking filtering performed by deblocking filter 222. Operations of deblocking filter 222 and pixel parameter generator 224 are the same as or similar to those of deblocking filter 102 and pixel parameter generator 104 of encoding unit 110, and thus, their detailed descriptions are omitted.

According to the above-described embodiment, by performing a deblocking filtering operation and a pixel parameter generating operation in parallel, a time taken in an encoding or decoding operation is shortened, and thus, a buffer of image transmitting apparatus 100 or image receiving apparatus 200 is efficiently used. Also, the generated pixel parameters may be independent of a deblocking filtering result, and thus, an encoding or decoding operation more robust to noise may be performed.

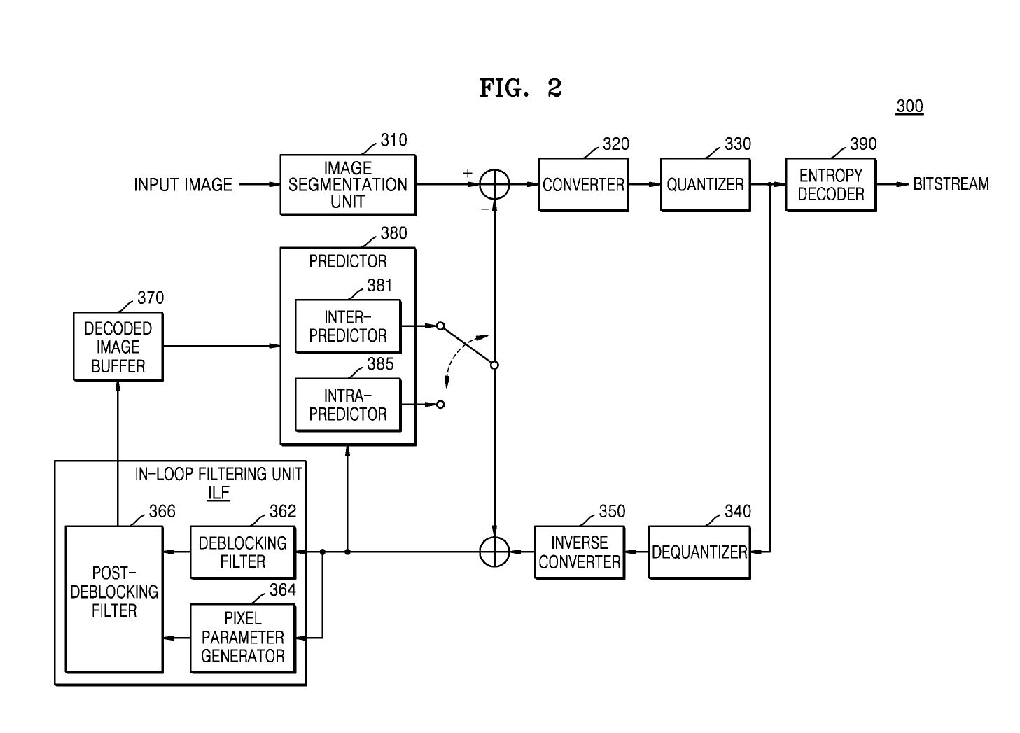

FIG. 2 is a block diagram of an embodiment of an encoding unit 300.

Referring to FIG. 2, encoding unit 300 (which may also be referred to as a image encoder) may include an image segmentation unit 310, a converter 320, a quantizer 330, a dequantizer 340, an inverse converter 350, an in-loop filtering unit ILF, a decoded image buffer 370, a predictor 380, and an entropy decoder 390. The in-loop filtering unit ILF may include a deblocking filter 362, a pixel parameter generator 364, and a post-deblocking filter 366. Predictor 380 may include an inter predictor 381 and an intra predictor 385.

Image segmentation unit 310 may segment an input image (or a picture or a frame), input to encoding unit 300, into one or more processing units. For example, each of the one or more processing units may be a coding tree unit (CTU), a CU, a prediction unit (PU), or a transform unit (TU).

However, the terms are merely used for convenience of description on the present disclosure, and the present disclosure is not limited to definition of a corresponding term. Also, in the present specification, for convenience of description, the term “coding unit” or “target unit” is used as a unit which is used in a process of encoding or decoding an image signal, but without the present disclosure being limited thereto, may be appropriately construed based on details.

Encoding unit 300 may subtract a prediction signal, output from inter predictor 381 or intra predictor 385, from the segmented image to generate a residual signal, and the generated residual signal may be transmitted to converter 320. Converter 320 may apply a transform technique to the residual signal to generate a transform coefficient. A conversion process may be applied to a square pixel block having a constant size, or may be applied to a non-square block having a variable size. Quantizer 330 may quantize the transform coefficient to transmit a quantized transform coefficient to entropy decoder 390, and entropy decoder 390 may entropy-decode a quantized signal to output the quantized signal as a bitstream. The quantized signal output from quantizer 330 may be used to generate the prediction signal. For example, the residual signal may be restored by applying a dequantization operation of dequantizer 340 and an inverse conversion operation of inverse converter 350 to the quantized signal. Here, dequantizer 340 and inverse converter 350 are connected in series. A restored image may be generated by a summer adding a restored residual signal to the prediction signal output from inter predictor 381 or intra predictor 385.

In general, adjacent blocks are quantized by different quantization parameters in the above-described compression process, causing deterioration where a block boundary is seen. In order to decrease the deterioration, a deblocking filter 362 may receive the restored image and perform deblocking filtering on the restored image. In an embodiment, a pixel parameter generator 364 may receive the restored image and may generate pixel parameters for post-deblocking filtering in parallel with a deblocking filtering operation. A filter parameter of a post-deblocking filter 366 may be determined based on the pixel parameters. Post-deblocking filter 366 may perform a post-deblocking filtering operation on a deblocked restored image by units of blocks so as to minimize a difference between an original image and the restored image, thereby generating a filtered signal.

The filtered signal transmitted to decoded image buffer 370 may be transmitted to a prediction filter (not shown), and a filtering operation for enhancing prediction performance may be performed on the filtered signal. For example, the prediction filter (not shown) may be a Wiener filter. Also, decoded image buffer 370 may store the filtered signal.

The filtered signal stored in decoded image buffer 370 may be transmitted to predictor 380 and may be used to generate the prediction signal. For example, the filtered signal may be used as a reference image by inter predictor 381. In this manner, encoding efficiency is enhanced by using the filtered signal as the reference image in an inter-prediction mode.

Inter predictor 381 may perform temporal prediction and/or spatial prediction for removing temporal redundancy and/or spatial redundancy with reference to the restored image or the filtered signal stored in decoded image buffer 370. Here, the reference image used to perform prediction may be a signal which is obtained through quantization and dequantization performed by units of blocks in encoding/decoding for a previous time, and a blocking artifact or a ringing artifact may be included in the reference image.

Therefore, in order to prevent performance from being reduced by quantization or discontinuity of a signal, inter predictor 381 may interpolate a signal between pixels by units of subpixels by using a low-pass filter. Here, a subpixel may denote a virtual pixel which is generated by applying an interpolation filter, and an integer pixel may denote an actual pixel which is included in the restored image. An interpolation method may use linear interpolation, bi-linear interpolation, and a Wiener filter.

The interpolation filter may be applied to the restored image to enhance a precision of prediction. For example, inter predictor 381 may apply an interpolation filter to the integer pixel to generate an interpolated pixel and may perform prediction by using an interpolated block including interpolated pixels as a prediction block.

Intra predictor 385 may predict a current block with reference to samples near a block on which encoding is to be currently performed. Intra predictor 385 may perform the following process for performing intra prediction. First, a reference sample necessary for generating the prediction signal may be prepared. Also, the prediction signal may be generated from the prepared reference sample. Subsequently, a prediction mode may be encoded. In this case, the reference sample may be prepared through a reference sample padding process and/or a reference sample filtering process. Since the reference sample should undergo a prediction and restoration process, a quantization error may occur. Therefore, in order to decrease the quantization error, the reference sample filtering process may be performed on each prediction mode used for intra prediction.

The prediction signal generated by inter predictor 381 or intra predictor 385 may be used to generate the restored image or the residual signal.

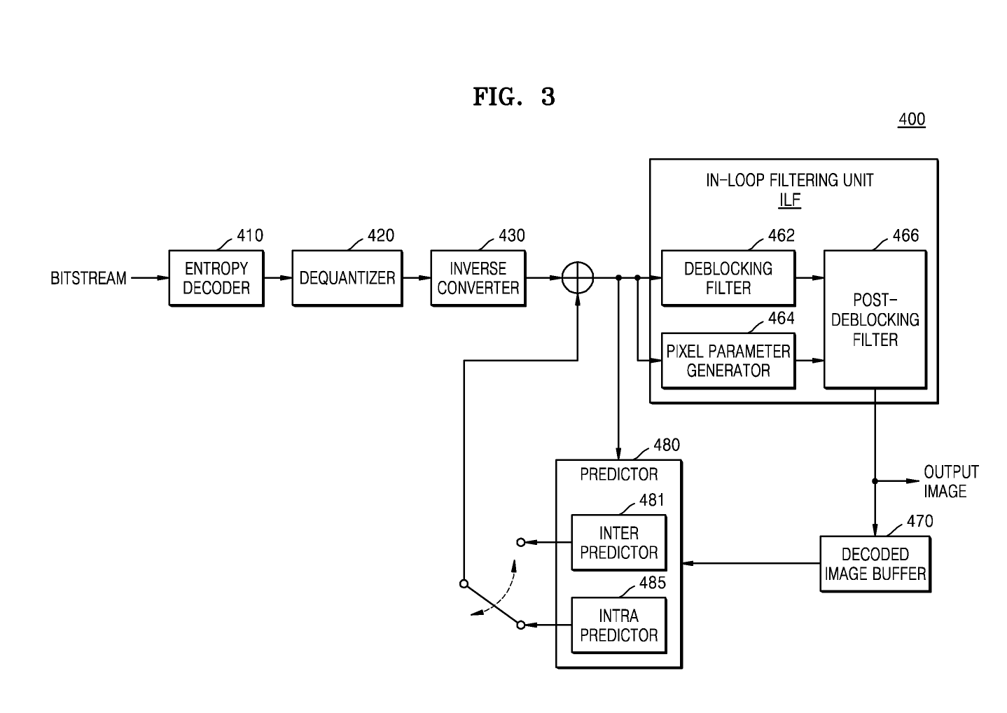

FIG. 3 is a schematic block diagram of an embodiment of a decoding unit 400.

Referring to FIG. 3, decoding unit 400 (which may also be referred to as an image decoder) may include an entropy decoder 410, a dequantizer 420, an inverse converter 430, an in-loop filtering unit ILF, a decoded image buffer 470, and a predictor 480.

A restored image output through decoding unit 400 may be reproduced by a reproduction apparatus. Decoding unit 400 may receive a bitstream, and the bitstream may be entropy-decoded by entropy decoder 410.

Dequantizer 420 and inverse converter 430 are connected in series. Dequantizer 420 may obtain a transform coefficient from an entropy-decoded signal, based on quantization step size information. Inverse converter 430 may perform inverse conversion on the transform coefficient to obtain a residual signal. A restored image may be generated by adding the obtained residual signal to a prediction signal output from an inter predictor 481 or an intra predictor 485.

The in-loop filtering unit ILF may include a deblocking filter 462, a pixel parameter generator 464, and a post-deblocking filter 466. Deblocking filter 462 may receive the restored image and perform deblocking filtering on the restored image. In an embodiment, pixel parameter generator 464 may receive the restored image and may generate pixel parameters for post-deblocking filtering in parallel with a deblocking filtering operation. Post-deblocking filter 466 may determine a filter parameter, based on the pixel parameters and may perform a post-deblocking filtering operation on a deblocked restored image by units of blocks so as to minimize a difference between an original image and the restored image, thereby generating a filtered signal.

In another embodiment, the filter parameter for post-deblocking filter 466 may be transmitted from encoding unit 300 of FIG. 2, or may be deduced from other coding information.

The in-loop filtering unit ILF may perform deblocking filtering and post-deblocking filtering to generate the filtered signal as an output image and may transmit the filtered signal to a reproduction apparatus and/or decoded image buffer 470. The filtered signal transmitted to decoded image buffer 470 may be transmitted to a prediction filter (not shown), and a filtering operation for enhancing prediction performance may be performed on the filtered signal.

The filtered signal stored in decoded image buffer 470 may be transmitted to predictor 480 and may be used to generate the prediction signal. For example, the filtered signal may be used as a reference image by inter predictor 481. Decoded image buffer 470 may store the filtered signal or a prediction filtered signal which is to be used as the reference image in inter predictor 481.

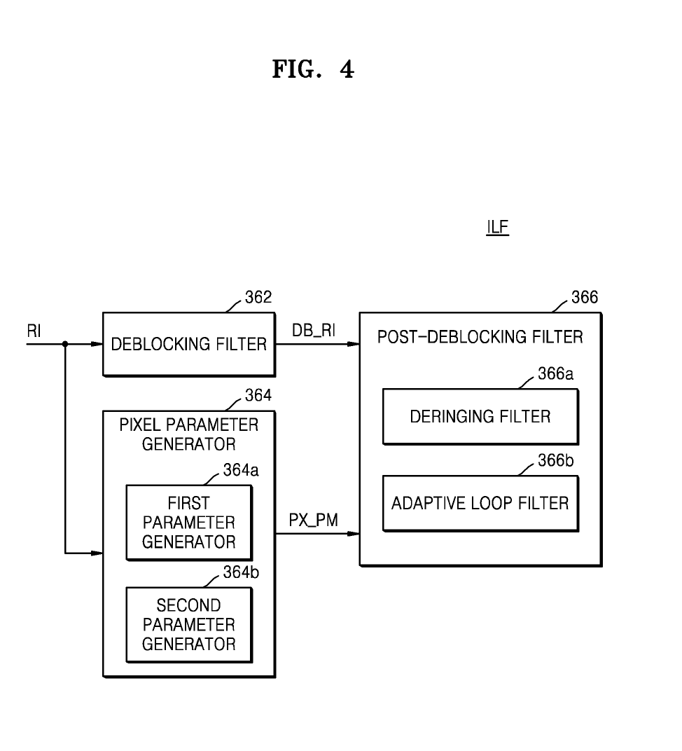

FIG. 4 is a schematic block diagram for describing an embodiment of an operation of the in-loop filtering unit ILF of FIG. 2 or 3.

Referring to FIG. 4, an in-loop filtering unit ILF may include a deblocking filter 362, a pixel parameter generator 364, and a post-deblocking filter 366. Post-deblocking filter 366 may include at least one of a deringing filter 366a and an adaptive loop filter 366b. In an embodiment, if post-deblocking filter 366 includes deringing filter 366a and adaptive loop filter 366b, post-deblocking filter 366 may sequentially perform a deringing filtering operation and an adaptive loop filtering operation. In other embodiments, an order in which the deringing filtering operation and the adaptive loop filtering operation are performed may be changed. A configuration of post-deblocking filter 366 illustrated in FIG. 4 is merely an example embodiment, and is not limited thereto. In other embodiments, post-deblocking filter 366 may further include one or more filters for effectively decreasing a difference between a restored image and an original image.

Deblocking filter 362 may receive a restored image RI and may perform a deblocking filtering operation on the restored image RI to generate a deblocked restored image DB_RI. In an embodiment, pixel parameter generator 364 may include a first parameter generator 364a and a second parameter generator 364b. First parameter generator 364a may generate a first pixel parameter for determining a filter parameter corresponding to deringing filter 366a, in parallel with the deblocking filter operation. The first pixel parameter may be generated by units by which deringing filter 366a is applied. Second parameter generator 364b may generate a second pixel parameter necessary for determining a filter parameter corresponding to adaptive loop filter 366b, in parallel with the deblocking filter operation. The second pixel parameter may be generated by units by which adaptive loop filter 366b is applied.

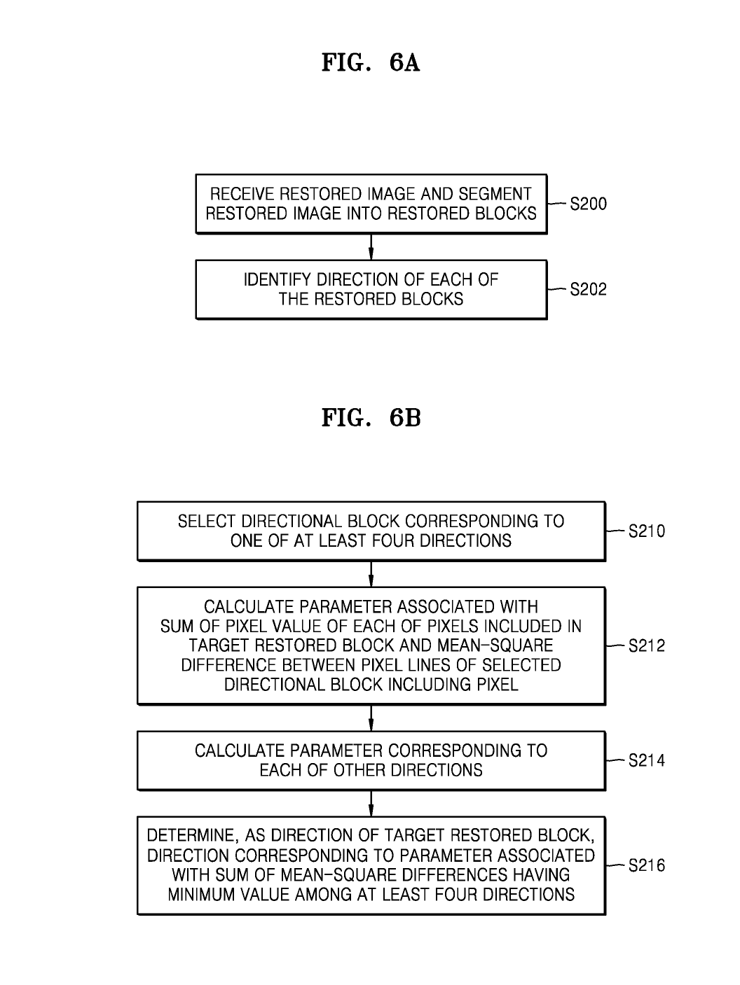

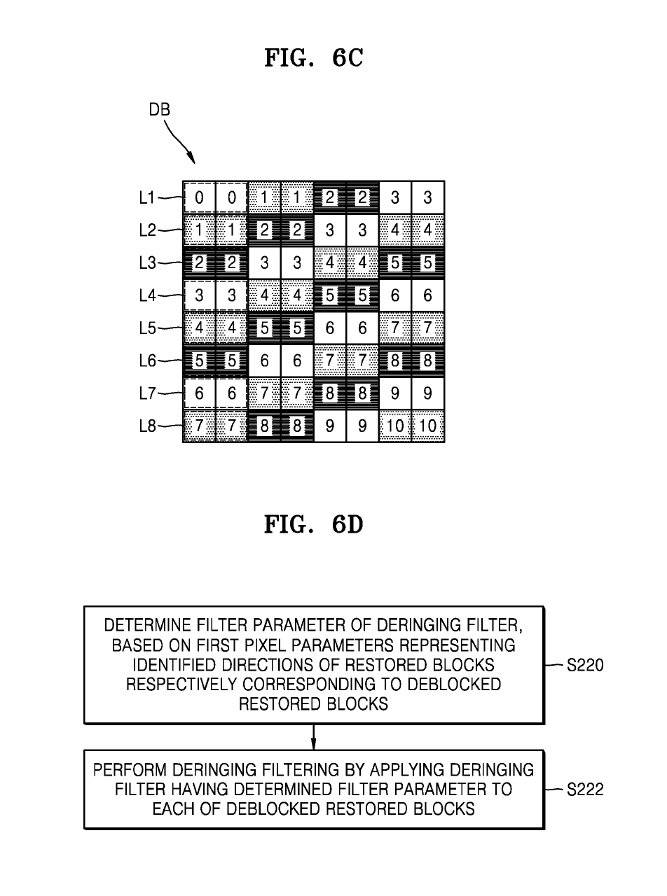

In an embodiment, first parameter generator 364a and second parameter generator 364b may respectively generate the first pixel parameter and the second pixel parameter in parallel with each other. Alternatively, first parameter generator 364a and second parameter generator 364b may sequentially generate the first pixel parameter and the second pixel parameter, based on a generation order suitable for an order in which the deringing filtering operation and the adaptive loop filtering operation are performed. For example, in a case where the adaptive loop filtering operation is performed after the deringing filtering operation, first parameter generator 364a may generate the first pixel parameter, and then second parameter generator 364b may generate the second pixel parameter. Details of the first pixel parameter will be described with reference to FIGS. 6A to 6D, and details of the second pixel parameter will be described with reference to FIG. 7.

Moreover, based on the kind of a filter included in post-deblocking filter 366, a larger number of parameter generators may be provided, and the parameter generators may generate pixel parameters in parallel with each other or in a certain order.

Post-deblocking filter 366 may receive the deblocked restored image DB_RI from deblocking filter 362 and may receive a pixel parameter PX_PM including at least one of the first pixel parameter and the second pixel parameter from pixel parameter generator 364.

First parameter generator 364a may generate a plurality of first pixel parameters by units of restored blocks (or units of maximum encoding) of the restored image on which deblocking filtering is to be performed, based on values of pixels included in each of the restored blocks. In detail, first parameter generator 364a may generate the first pixel parameters corresponding to information representing a direction of each restored block by using the values of the pixels included in each restored block.

A filter parameter of deringing filter 366a may be determined with reference to the first pixel parameters, based on a direction of a restored block corresponding to restored blocks included in the deblocked restored image DB_RI. For example, a deringing filter 366a having a first filter parameter may be applied to a first restored block having a first direction, and a deringing filter 366a having a second filter parameter may be applied to a second restored block having a second direction. For example, the filter parameter of deringing filter 366a may include information which is used to change a position of a tap of deringing filter 366a to a position of a restored block. That is, the filter parameter of deringing filter 366a may denote a value of a deringing filter which is determined for a deringing filtering operation. Deringing filter 366a may remove a deringing artifact in an edge near a boundary between restored blocks of the deblocked restored image DB_RI. For example, a restored image to which deringing filter 366a is applied may be an image obtained through adaptive loop filtering of the deblocked restored image DB_RI.

Adaptive loop filter 366b may correct a value of a current pixel of which a pixel value is to be corrected, based on a correction value which is determined by performing an arithmetic operation on a value of a peripheral pixel disposed near the current pixel and a coefficient corresponding to the peripheral pixel. Adaptive loop filter 366b may correct a pixel value by units of restored blocks (or units of maximum encoding) of a restored image. The restored image may be the deblocked restored image DB_RI or a deringing filtered restored image. A filter parameter of the adaptive loop filter 366b may be determined based on a second pixel parameter. That is, in a case where an adaptive loop filtering operation is performed on a target restored block, at least one of a shape, a size, and a coefficient of adaptive loop filter 366b may be determined based on the second pixel parameter.

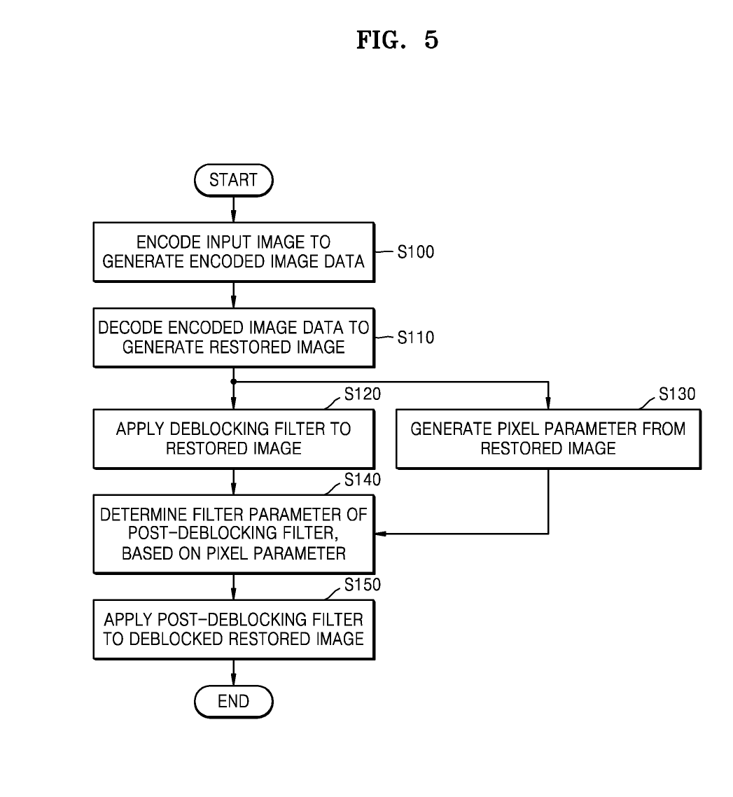

FIG. 5 is a flowchart for describing an embodiment of a filtering method.

Referring to FIG. 5, an image processing apparatus (for example, image transmitting apparatus 100 of FIG. 1) may encode an input image to generate encoded image data in operation S100. The image processing apparatus may decode the encoded image data to generate a restored image in operation S110. Subsequently, the image processing apparatus may apply a deblocking filter to the restored image to generate a deblocked restored image in operation S120. Also, in operation S130, the image processing apparatus may generate a pixel parameter by units of restored blocks included in the restored image by using the restored image, in parallel with the deblocking filtering operation S120. in operation S140, the image processing apparatus may determine a filter parameter corresponding to a post-deblocking filter, based on the pixel parameter generated in operation S130. in operation S150, the image processing apparatus may apply the post-deblocking filter to the deblocked restored image which was obtained in operation S120 through deblocking filtering by the deblocking filter to produce a filtered signal, which may be stored in a decoded image buffer (see FIGS. 3 and 4, above).

A feature where the image processing apparatus performs a deblocking filtering operation (e.g., operation S120) and a pixel parameter generating operation (e.g., and operation S130) in parallel with each other may be applied to image receiving apparatus 200 of FIG. 1. As a result of this beneficial filtering method, the processing time can be reduced and the pixel parameter does not depend on the accuracy of the deblocking filtering result.

FIGS. 6A to 6C are diagrams for describing details of the first pixel parameter of FIG. 4, and FIG. 6D is a diagram for describing a deringing operation.

Referring to FIGS. 4 and 6A, in operation S200, first parameter generator 364a may receive the restored image RI and may segment the restored image RI into a plurality of restored blocks. The plurality of restored blocks may each have a constant or variable size. Subsequently, in operation S202, first parameter generator 364a may identify a direction of each of the restored blocks. In an embodiment, first parameter generator 364a may determine a direction matching a pattern of pixels included in each of the restored blocks to identify the direction of each of restored blocks and may generate first pixel parameters based on a result of the identification. First parameter generator 364a may identify the direction of each of the restored blocks in various manners, and one embodiment for identifying the direction of each of the restored blocks will be described below with reference to FIGS. 6B and 6C.

Referring to 6B, first parameter generator 364a may perform an operation of sequentially identifying a direction corresponding to each of restored blocks on all restored blocks or some restored blocks. Hereinafter, an operation of first parameter generator 364a for identifying a direction of a target restored block, on which an identification operation is to be performed, of restored blocks will be described below.

Before describing an operation of first parameter generator 364a, a directional block DB will be described with reference to FIG. 6C. The directional block DB may have a line number of each of pixels in a certain direction. For example, the directional block DB may include a plurality of pixel lines in a diagonal direction, and pixels included in a left upper corner line L1 of the directional block DB may each have a value “0”. In this manner, pixels included in pixel lines L1 to L8 of the directional block DB may respectively have certain values “0 to 7”. The pixel lines L1 to L8 of the directional block DB may correspond to one direction of a set of predetermined directions. In an embodiment, the pixel lines L1 to L8 of the directional block DB may correspond to one of four predetermined directions. The four predetermined directions may respectively be a 0-degree direction, a 45-degree direction, a 90-degree direction, and a 135-degree direction, and the directional block DB illustrated in FIG. 6C may have a 45-degree direction.

Returning to FIG. 6B, in operation S210, first parameter generator 364a may select a directional block corresponding to one of at least four directions. In operation S212, first parameter generator 364a may calculate a parameter associated with a sum of a pixel value of each of pixels included in a target restored block and a mean-square difference between pixel lines of the selected directional block including a pixel. In operation S214, first parameter generator 364a may calculate a parameter corresponding to each of the other directions by using directional blocks respectively corresponding to the other directions in the above-described manner In operation S216, first parameter generator 364a may determine, as a direction of the target restored block, a direction corresponding to a parameter associated with a sum of mean-square differences having a minimum value among the at least four directions. First parameter generator 364a may select a next target restored block and may perform operations S210 to S216. As a result, first parameter generator 364a may identify directions of restored blocks and may generate first pixel parameters representing the directions of the restored blocks.

Referring to FIG. 6D, in operation S220, a filter parameter of deringing filter 366a may be determined based on first pixel parameters representing identified directions of restored blocks respectively corresponding to deblocked restored blocks. The deblocked restored blocks may be included in a deblocked restored image DB_RI. Subsequently, in operation S222, a deringing filtering operation may be performed by applying deringing filter 366a having the determined filter parameter to each of the deblocked restored blocks.

FIG. 7 is a diagram for describing details of a second pixel parameter of FIG. 4.

Referring to FIG. 7, sample pixels A to I in a restored block (or a maximum CU) to which an adaptive loop filter is applied are illustrated, a sample pixel E represents a current sample pixel, and sample pixels A, B, C, D, F, G, H, and I represent peripheral sample pixels. A variation of the sample pixel E in a vertical direction may be seen based on differences between the sample pixel E and the sample pixels B and H, and a variation of the sample pixel E in a horizontal direction may be seen based on differences between the sample pixel E and the sample pixels D and F. A variation in a left-upward diagonal direction may be seen based on differences between the sample pixel E and the sample pixels A and I, and a variation in a right-upward diagonal direction may be seen based on differences between the sample pixel E and the sample pixels C and G. An image characteristic of the sample pixel E may be seen based on the variation in the horizontal direction, the variation in the vertical direction, and the variation in the diagonal direction and may represent a complexity of an image, and an activity of an image in a restored block may be calculated based on the image characteristic. The activity may be an indicator indicating a characteristic of an error or a texture in a target restored block on which filtering is to be performed. Also, a directionality of an image in a corresponding region may be obtained by comparing the variation in the variation in the vertical direction, the horizontal direction, and the variation in the diagonal direction. The activity may be an indicator indicating a directionality of an error or a texture in the target restored block on which filtering is to be performed.

In the example of FIG. 7, a characteristic of an image may be calculated by using nine sample pixels, but in other examples it may be calculated by more or fewer sample pixels.

In an embodiment, a second pixel parameter may be information representing at least one of activity and directionality of a target restored block on which adaptive loop filtering is to be performed. As described above, a filter parameter of adaptive loop filter 366b of FIG. 4 may be determined based on the second pixel parameter. For example, at least one of a shape, a size, and a coefficient of adaptive loop filter 366b may be determined based on the second pixel parameter. However, this is merely an example embodiment, and the present embodiment is not limited thereto. In other embodiments, the second pixel parameter may be implemented as various pieces of information necessary for determining at least one of the shape, size, and coefficient of adaptive loop filter 366b.

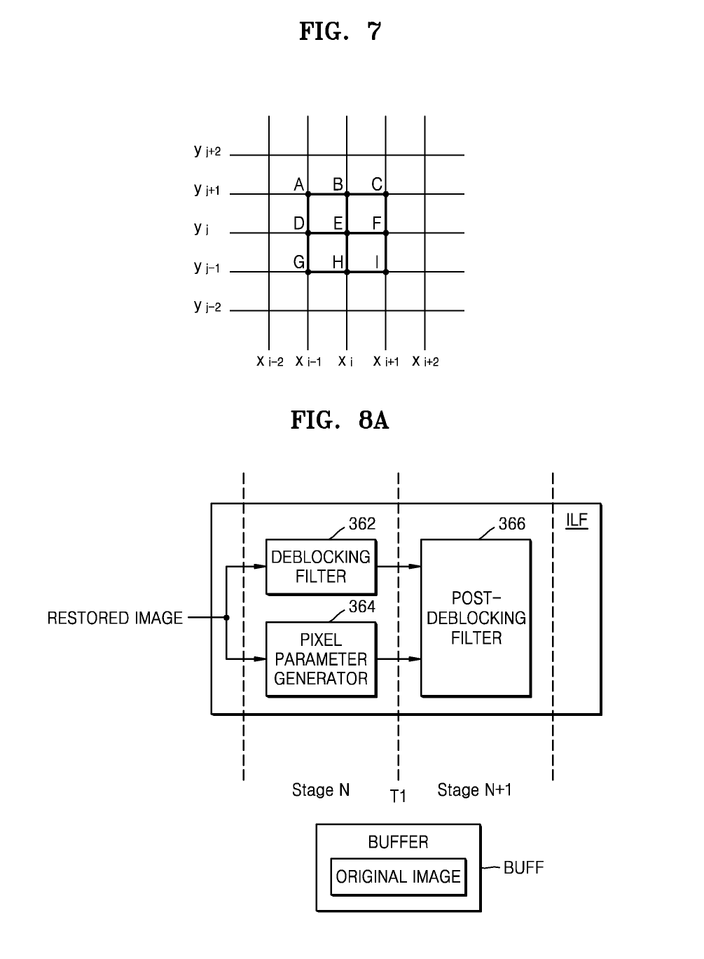

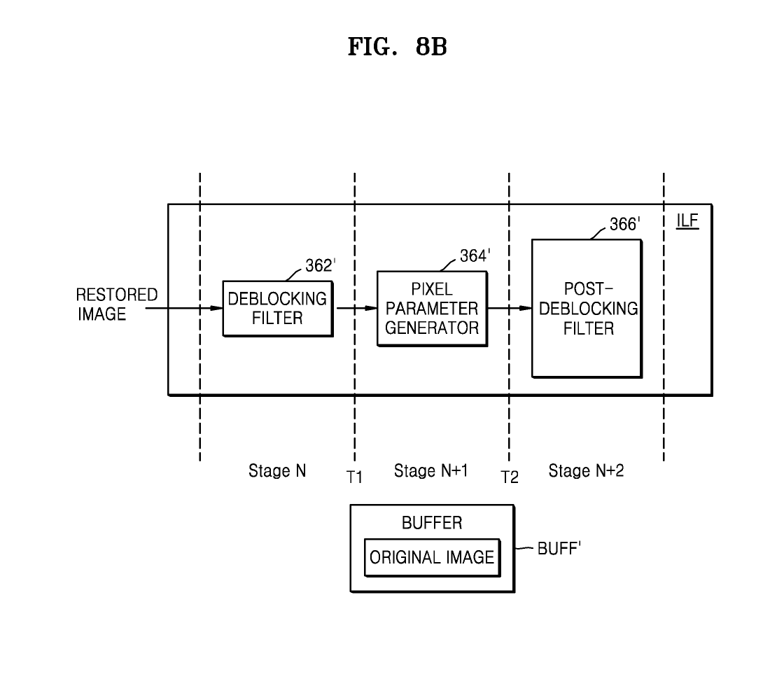

FIGS. 8A and 8B are diagrams for describing the use of a buffer of an embodiment of an image processing apparatus.

Referring to FIG. 8A, an in-loop filtering unit ILF of the image processing apparatus according to an embodiment includes deblocking filter 362 and pixel parameter generator 364 which are implemented to perform a deblocking filtering operation and a pixel parameter generating operation in parallel by using a restored image in an Nth stage Stage N. The image processing apparatus may further include a buffer BUFF, and the buffer BUFF may store an original image corresponding to the restored image until before post-deblocking filter 366 performs a post-deblocking filtering operation. The original image may be used in the image processing apparatus until before performing the post-deblocking filtering operation in an N+1st stage Stage N+1. Therefore, the original image stored in the buffer BUFF may be deleted after a time T1 when the Nth stage Stage N is completed. In another embodiment, the original image stored in the buffer BUFF may be deleted when a deblocked restored image and generated pixel parameters are completely transmitted to post-deblocking filter 366.

Referring to FIG. 8B, an in-loop filtering unit ILF′ of a related art image processing apparatus may include a deblocking filter 362′ and a pixel parameter generator 364′ which are implemented to serially perform a deblocking filtering operation using a restored image in an Nth stage Stage N and a pixel parameter generating operation using a deblocked restored image in an N+1st stage Stage N+1. The image processing apparatus may further include a buffer BUFF, and the buffer BUFF may store an original image corresponding to the restored image until before a post-deblocking filter 366′ performs a post-deblocking filtering operation. The original image may be used in the image processing apparatus until before performing the post-deblocking filtering operation in an N+2nd stage Stage N+2. Therefore, the original image stored in the buffer BUFF may be deleted after a time T2 when the N+1st stage Stage N+1 is completed.

Since the image processing apparatus according to an embodiment of the present disclosure performs the deblocking filtering operation and the pixel parameter generating operation in parallel with each other, the number of stages until performing the post-deblocking filtering operation is reduced, and a time for which the buffer BUFF stores the original image corresponding to the restored image is shortened. Also, another original image may be stored in a space, from which the original image is deleted, of the buffer BUFF, and thus, the buffer BUFF is efficiently used, thereby decreasing a size of the buffer BUFF.

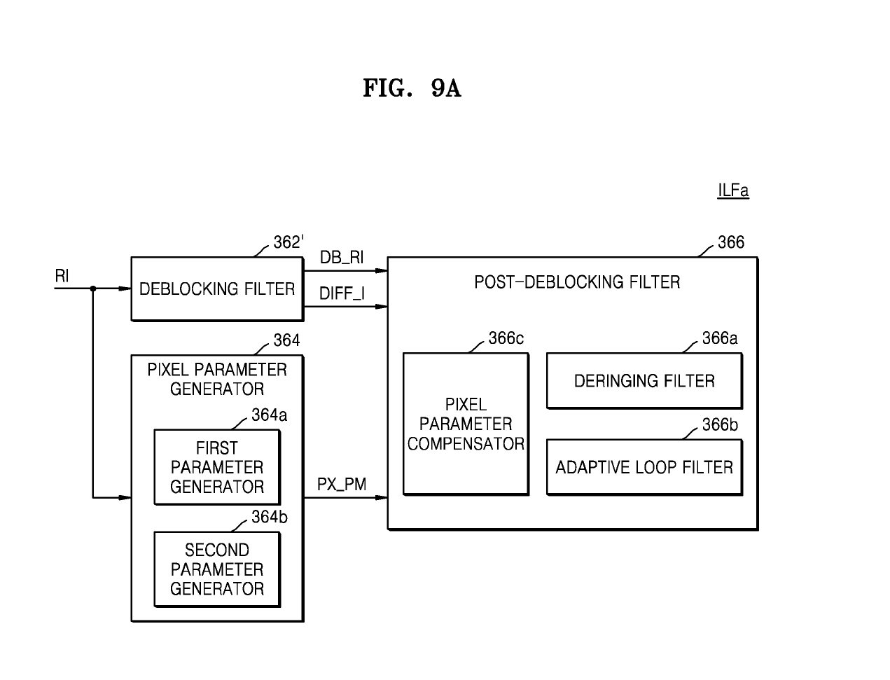

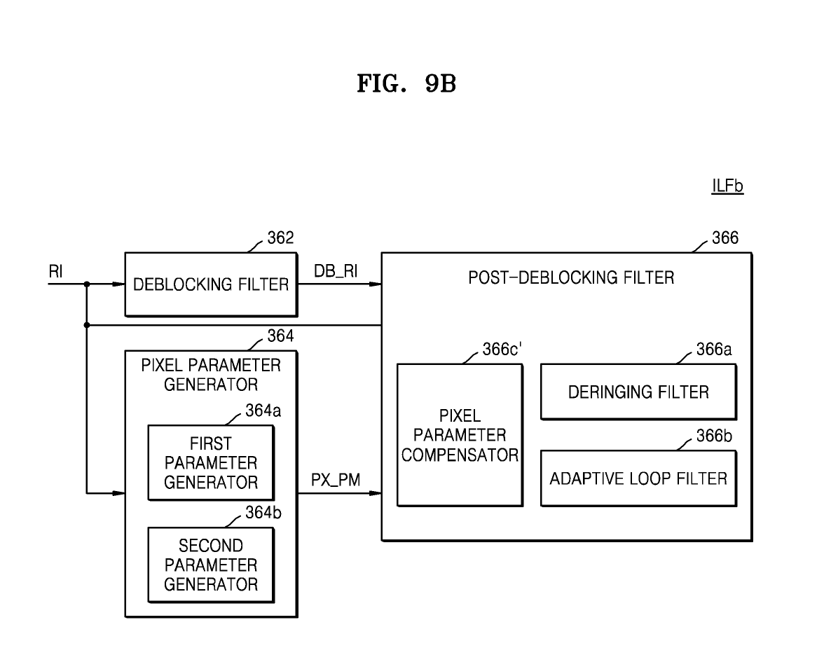

FIGS. 9A and 9B are diagrams for describing an operation of an example embodiment of an in-loop filtering unit ILFa associated with pixel parameter compensation.

Referring to FIG. 9A, the in-loop filtering unit ILFa may include deblocking filter 362′, pixel parameter generator 364, and post-deblocking filter 366. Deblocking filter 362′ may receive a restored image RI and may perform deblocking filtering on the restored image RI to generate a deblocked restored image DB_RI. In an embodiment, deblocking filter 362′ may generate difference information DIFF_I representing a pixel value difference between the restored image RI and the deblocked restored image DB_RI. The difference information DIFF_I may be generated for each of restored blocks of the deblocked restored image DB_RI.

Pixel parameter generator 364 may include a first parameter generator 364a and a second parameter generator 364b. Pixel parameter generator 364 has been described in detail above with reference to FIG. 4, and thus, its detailed description is not repeated. Pixel parameter generator 364 may generate a pixel parameter PX_PM necessary for determining a pixel parameter for post-deblocking filter 366.

In an embodiment, post-deblocking filter 366 may include deringing filter 366a, adaptive loop filter 366b, and a pixel parameter compensator 366c. Pixel parameter compensator 366c may receive the difference information DIFF_I and the pixel parameter PX_PM. Pixel parameter compensator 366c may compensate for the pixel parameter PX_PM, based on the difference information DIFF_I. That is, pixel parameter compensator 366c may recognize a block artifact component of the restored block RI, based on the difference information DIFF_I and may compensate for the pixel parameter PX_PM in order for the block artifact component to be removed from the pixel parameter PX_PM in which the block artifact component is reflected. Pixel parameter compensator 366c may provide a compensated pixel parameter to deringing filter 366a and/or adaptive loop filter 366b. Deringing filter 366a and adaptive loop filter 366b have been described in detail above with reference to FIG. 4, and thus, their detailed descriptions are not repeated.

Referring to FIG. 9B, unlike FIG. 9A, a pixel parameter compensator 366c′ may receive a restored image RI, a deblocked restored image DB_RI, and a pixel parameter PX_PM. Pixel parameter compensator 366c′ may generate difference information representing a pixel value difference between the restored image RI and the deblocked restored image DB_RI. The difference information may include information corresponding to each of restored blocks of the deblocked restored image DB_RI. Pixel parameter compensator 366c′ may compensate for the pixel parameter PX_PM, based on the difference information. Other elements are the same as or similar to FIG. 9A, and thus, their detailed descriptions are not repeated.

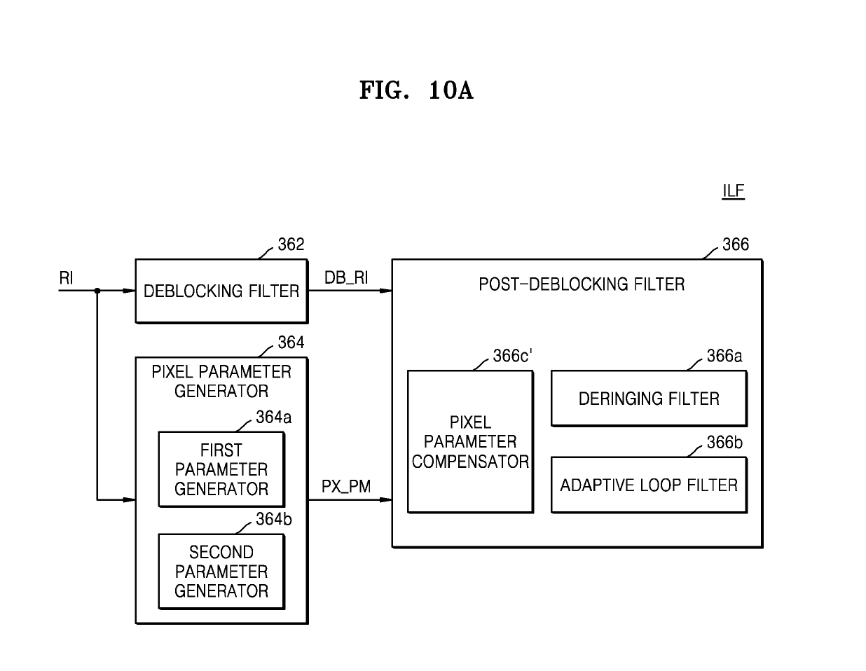

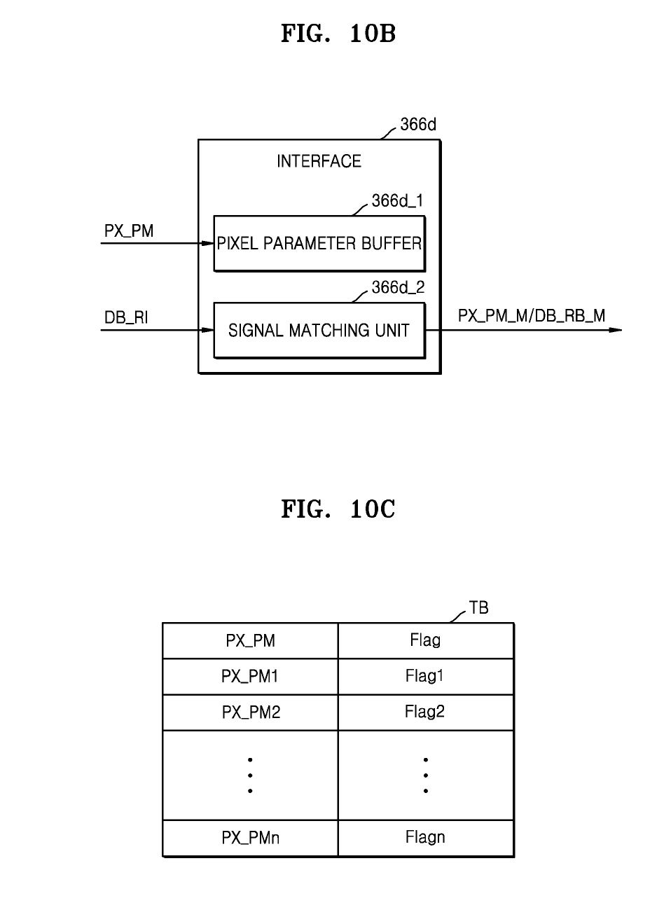

FIGS. 10A to 10C are diagrams for describing an operation of an example embodiment of an in-loop filtering unit ILF.

Referring to FIG. 10A, the in-loop filtering unit ILF may include deblocking filter 362, pixel parameter generator 364, and post-deblocking filter 366. In an embodiment, pixel parameter generator 364 may adjust an output timing of a pixel parameter PX_PM so as to match an output timing when deblocking filter 362 outputs a deblocked restored image DB_RI to post-deblocking filter 366. In an embodiment, pixel parameter generator 364 may earlier complete a pixel parameter generating operation using a restored image RI than a deblocking filtering operation of deblocking filter 362. At this time, pixel parameter generator 364 may output the pixel parameter PX_PM at a timing matching an output timing when deblocking filter 362 outputs the deblocked restored image DB_RI, without immediately outputting the generated pixel parameter PX_PM to post-deblocking filter 366. Pixel parameter generator 364 may further include a delay circuit for adjusting an output timing of the pixel parameter PX_PM. The delay circuit may include a plurality of delay elements. However, this is merely an example embodiment, and the present embodiment is not limited thereto. In other embodiments, in a case where the pixel parameter generating operation of pixel parameter generator 364 is completed later than the deblocking filtering operation of deblocking filter 362, an output timing when deblocking filter 362 outputs the deblocked restored image DB_RI may be adjusted.

Post-deblocking filter 366 may include deringing filter 366a, adaptive loop filter 366b, and pixel parameter compensator 366c′. Pixel parameter compensator 366c′ may receive the deblocked restored image DB_RI and the pixel parameter PX_PM having the same or similar output timings and may output the deblocked restored image DB_RI and the pixel parameter PX_PM to at least one of deringing filter 366a and adaptive loop filter 366b.

Referring to FIG. 10B, unlike FIG. 10A, pixel parameter generator 364 may immediately output the generated pixel parameter PX_PM to an interface 366d without adjusting an output timing of the pixel parameter PX_PM. Interface 366d may include a pixel parameter buffer 366d_1 and a signal matching unit 366d_2. In FIG. 10B, interface 366d may be included in post-deblocking filter 366, but this is merely an example embodiment. Embodiments are not limited thereto, and interface 366d may be disposed outside post-deblocking filter 366. Pixel parameter buffer 366d_1 may sequentially store pixel parameters PX_PM received from pixel parameter generator 364. Referring to FIG. 10C, interface 366d may generate and manage flag information Flag suitable for an order in which the pixel parameters PX_PM are stored. For example, pixel parameter buffer 366d_1 may sequentially store first to nth pixel parameters PX_PM1 to PX_PMn respectively corresponding to restored blocks of a deblocked restored image, and interface 366d may generate pieces of flag information Flag1 to Flagn suitable for a storage order and may tag the pieces of flag information Flag1 to Flagn to the first to nth pixel parameters PX_PM1 to PX_PMn.

Signal matching unit 366d_2 may match a first-stored pixel parameter PX_PM with a restored block corresponding to the first-stored pixel parameter PX_PM with reference to flag information of a table TB and may simultaneously output a matched pixel parameter PX_PM_M and a matched restored block DB_RB_M to at least one of deringing filter 366a and adaptive loop filter 366b.

Deringing filter 366a and/or adaptive loop filter 366b may determine a filter parameter with reference to the matched pixel parameter PX_PM_M and may perform a post-deblocking filtering operation on the matched restored block DB_RB_M.

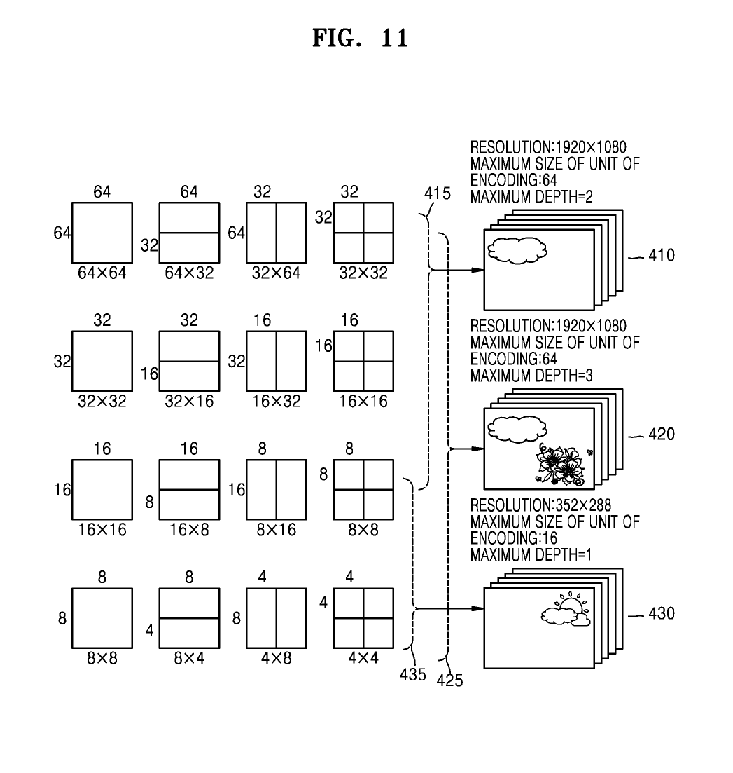

FIG. 11 illustrates a concept of an embodiment of a unit of encoding.

A unit of encoding may be a unit corresponding to the above-described conversion size or CU.

Referring to FIG. 11, a size of a unit of encoding may be expressed as width×height and may include 32×32, 16×16, and 8×8 sizes from a maximum unit of encoding having a 64×64 size. A maximum unit of encoding having a 64×64 size may be segmented into units of encoding respectively having 64×64, 64×32, 32×64, and 32×32 sizes; a unit of encoding having a 32×32 size may be segmented into units of encoding respectively having 32×32, 32×16, 16×32, and 16×16 sizes; a unit of encoding having a 16×16 size may be segmented into units of encoding respectively having 16×16, 16×8, 8×16, and 8×8 sizes; and a unit of encoding having a 8×8 size may be segmented into units of encoding respectively having 8×8, 8×4, 4×8, and 4×4 sizes.

For example, in a frame image A, a resolution may correspond to 1920×1080, a maximum size of a unit of encoding may be set to 64, and a maximum depth may be set to 2. Alternatively, in a frame image B, a resolution may correspond to 1920×1080, a maximum size of a unit of encoding may be set to 64, and a maximum depth may be set to 3. Alternatively, in a frame image C, a resolution may correspond to 352×288, a maximum size of a unit of encoding may be set to 16, and a maximum depth may be set to 1. A maximum depth illustrated in FIG. 11 may represent the total number of segmentations from a maximum unit of encoding to a minimum unit of encoding.

In a case where a resolution is high or the amount of data is large, encoding efficiency is enhanced, and moreover, a maximum size of a unit of encoding may be relatively large for accurately reflecting an image characteristic. Accordingly, in the frames A and B having high resolution, a maximum size of a unit of encoding may be selected as 64.

Since the maximum depth of the frame image A is 2, a unit D of encoding of the frame image A may include a maximum unit of encoding having a long-axis size “64” to units of encoding which respectively have long-axis sizes “32” and “16” because a depth is deepened by two layers through twice segmentation. On the other hand, since the maximum depth of the frame image C is 1, a unit F of encoding of the frame image C may include units of encoding having a long-axis size “16” to units of encoding which have long-axis sizes “8” because a depth is deepened by one layer through one segmentation.

Since the maximum depth of the frame image B is 3, a unit G of encoding of the frame image B may include a maximum unit of encoding having a long-axis size “64” to units of encoding which respectively have long-axis sizes “32”, “16”, and “8” because a depth is deepened by three layers through three-time segmentation. As the depth is deepened, an ability to express detailed information is enhanced.

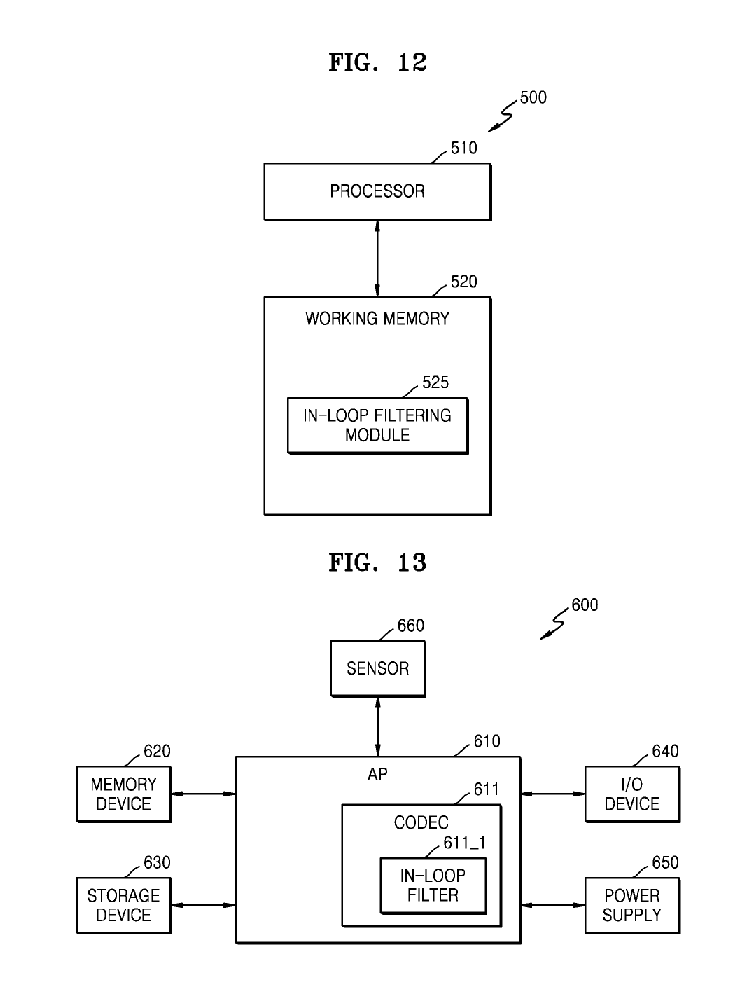

FIG. 12 is a block diagram illustrating an example where an embodiment of an image processing method is implemented by a processor executing software.

Referring to FIG. 12, an image processing apparatus 500 may include a processor 510 and a working memory 520. Working memory 520 may be a computer-readable recording medium. Processor 510 may execute computer programs stored in working memory 520. Working memory 520 may store computer programs for processing, with software, at least some of various functions of performing the filtering operations according to the above-described embodiments, and each of the computer programs may include an in-loop filtering module 525, based on a function thereof.

In an embodiment, processor 510 may overall control a filtering operation on a restored image according to the above-described embodiments. For example, processor 510 may execute in-loop filtering module 525 to perform a deblocking filtering operation and a pixel parameter generating operation in parallel. Also, processor 510 may execute in-loop filtering module 525, and thus, may perform operations associated with the control of an output timing and management of pixel parameters required in performing the parallel operations.

FIG. 13 is a block diagram illustrating a computing system 600 including an embodiment of an image processing apparatus.

Referring to FIG. 13, computing system 600 may include an application processor 610, a memory device 620, a storage device 630, an input/output (110) device 640, a power supply 650, and an image sensor 660. Although not shown in FIG. 13, computing system 600 may further include a plurality of ports for communicating with a video card, a sound card, a memory card, a universal serial bus (USB) device, etc., or communicating with other electronic devices.

Application processor 610 may be implemented as a system-on chip (SoC). Application processor 610 may perform certain calculations or tasks. According to embodiments, application processor 610 may be a microprocessor or a central processing unit (CPU). Application processor 610 may communicate with memory device 620, storage device 630, and I/O device 640 through an address bus, a control bus, and a data bus. Memory device 620 may store data necessary for an operation of computing system 600. For example, memory device 620 may be implemented with dynamic random access memory (DRAM), mobile DRAM, static random access memory (SRAM), flash memory, phase random access memory (PRAM), ferroelectric random access memory (FRAM), resistive random access memory (RRAM), and/or magnetoresistive random access memory (MRAM). Storage device 630 may include a solid state drive (SSD), a hard disk drive (HDD), a compact disc read-only memory (CD-ROM), and/or the like. I/O device 640 may include an input means such as a keyboard, a keypad, and a mouse device and an output means such as a printer and a display. Power supply 650 may supply an operation voltage necessary for an operation of computing system 600.

Application processor 610 may include a codec module 611 which performs an image processing operation according to an embodiment, and codec module 611 may include an in-loop filter 611_1. In-loop filter 611_1 may perform a deblocking filtering operation and a pixel parameter generating operation in parallel with each other.

The various operations of methods described above may be performed by any suitable means capable of performing the operations, such as various hardware and/or software component(s), circuits, and/or module(s).

The software may comprise an ordered listing of executable instructions for implementing logical functions, and can be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

While the inventive concept has been particularly shown and described with reference to embodiments thereof, it will be understood that various changes in form and details may be made therein without departing from the spirit and scope of the following claims.

1. An image processing apparatus, comprising:
a deblocking filter configured to receive a restored image and to perform deblocking filtering for removing at least some deterioration of a boundary between a plurality of restored blocks included in the restored image to produce a deblocked restored image;
a pixel parameter generator configured to receive the restored image and in response thereto to generate pixel parameters of the plurality of restored blocks, in parallel with the deblocking filtering; and
a post-deblocking filter configured to receive the pixel parameters and the deblocked restored image and to perform post-deblocking filtering on the plurality of restored blocks, based on the pixel parameters.

2. The image processing apparatus of claim 1, further comprising a buffer configured to store an original image corresponding to the restored image,
wherein, when the deblocked restored image generated as a result of the deblocking filtering and the generated pixel parameters are completely transmitted to the post-deblocking filter, the original image is deleted from the buffer.

3. The image processing apparatus of claim 1, wherein the post-deblocking filter comprises at least one of a deringing filter and an adaptive loop filter.

4. The image processing apparatus of claim 3, wherein a filter parameter of the deringing filter is determined based on a direction corresponding to each of the plurality of restored blocks with reference to the pixel parameters.

5. The image processing apparatus of claim 3, wherein the adaptive loop filter performs filtering on the deblocked restored image, based on at least one of a shape, a size, and a coefficient of the adaptive loop filter determined based on the pixel parameters.

6. The image processing apparatus of claim 1, wherein the pixel parameter generator comprises a delay circuit configured to adjust a first output timing of each of the pixel parameters so that the first output timing when the pixel parameters are output to the post-deblocking filter matches a second output timing when the deblocking filter outputs the deblocked restored image to the post-deblocking filter.

7. The image processing apparatus of claim 1, further comprising a buffer configured to store the pixel parameters in an order in which the pixel parameters are generated by the pixel parameter generator,
wherein the post-deblocking filter performs the post-deblocking filtering by units of restored blocks on the deblocked restored image with reference to a pixel parameter which corresponds to a target restored block and is stored in the buffer.

8. A filtering method for a restored image, the filtering method comprising:
a deblocking filter performing deblocking filtering for removing at least some deterioration of a boundary between a plurality of restored blocks included in the restored image;
a filter parameter generator generating pixel parameters of the plurality of restored blocks in parallel with performing the deblocking filtering; and
a post-deblocking filter performing post-deblocking filtering on the plurality of restored blocks, based on the pixel parameters.

9. The filtering method of claim 8, wherein each of the pixel parameters is information for determining a filter parameter for the post-deblocking filter which performs the post-deblocking filtering.

10. The filtering method of claim 8, wherein the generating of the pixel parameters comprises adjusting a first output timing when the pixel parameters are output to a post-deblocking filter for performing the post-deblocking filtering, so as to match a second output timing when a deblocked restored image is output to the post-deblocking filter.

11. The filtering method of claim 8, further comprising:
sequentially storing the pixel parameters in a buffer; and
simultaneously outputting to a post-deblocking filter which performs the post-deblocking filtering: a first deblocked restored block of a plurality of deblocked restored blocks; and a first pixel parameter, corresponding to the first deblocked restored block, of the pixel parameters.

12. The filtering method of claim 8, wherein the performing of the post-deblocking filtering comprises applying a deringing filter to a plurality of deblocked restored blocks.

13. The filtering method of claim 12, wherein each of the pixel parameters is information representing a direction of the restored block corresponding to each of the plurality of deblocked restored blocks to which the deringing filter is applied.

14. The filtering method of claim 8, wherein the performing of the post-deblocking filtering comprises applying an adaptive loop filter to a plurality of deblocked restored blocks.

15. The filtering method of claim 14, wherein each of the pixel parameters is information for determining at least one of a shape, a size, and a coefficient of the adaptive loop filter associated with the deblocked restored block to which the adaptive loop filter is applied.

16. The filtering method of claim 8, wherein the performing of the post-deblocking filtering comprises:
applying a deringing filter to a plurality of deblocked restored blocks; and
applying an adaptive loop filter to the plurality of deblocked restored blocks to which the deringing filter is applied.

17-20. (canceled)

21. A device, comprising:
an in-loop filtering device, comprising:
a deblocking filter configured to receive a restored image including a plurality of restored blocks, and to perform deblocking filtering for removing at least some deterioration of a boundary between the plurality of restored blocks to produce a deblocked restored image;
a pixel parameter generator configured to receive the restored image and, in parallel with the deblocking filtering, to generate from the restored image pixel parameters of the plurality of restored blocks; and
a post-deblocking filter configured to receive the pixel parameters and the deblocked restored image and to perform post-deblocking filtering on the plurality of restored blocks, based on the pixel parameters, to produce a filtered signal;
a decoded image buffer configured to receive and store the filtered signal; and
a predictor configured to receive the filtered signal from the decoded image buffer and in response thereto to produce a prediction signal.

22. The device of claim 21, wherein the post-deblocking filter includes at least one of a deringing filter and an adaptive loop filter.

23. The device of claim 22, wherein the post-deblocking filter is configured to derive from the pixel parameters at least one filter parameter for the at least one of the deringing filter and the adaptive loop filter.

24. The device of claim 21, further comprising:
a dequantizer and an inverse converter connected in series to output a residual signal; and
a summer configured to add the residual signal to the prediction signal to produce the restored image and to provide the restored image to the deblocking filter and to the pixel parameter generator.

25-26. (canceled)
